(19) United States
(12) Patent Application Publication
(10) Pub. No.: US 2013/0318922 A1
(43) Pub. Date: Dec. 5, 2013

(54) CANNULA HOLDERS

(71) Applicant: Meredith A. LLOYD, Susanville, CA (US)

(72) Inventor: Meredith A. LLOYD, Susanville, CA (US)

(73) Assignee: NOSOCOMIAL CONTAINMENT PRODUCTS INC., Chico, CA (US)

(21) Appl. No.: 13/541,723

(22) Filed: Jul. 4, 2012

Related U.S. Application Data
(60) Provisional application No. 61/653,010, filed on May 30, 2012.

(51) Int. Cl. A61J 1/00; B65D 30/02; B65D 33/14; B65B 55/04; B65B 61/02; B65D 30/06; B65B 5/04

(52) U.S. Cl. 53/411; 383/105; 206/459.5; 383/102; 53/410

(57) ABSTRACT

Cannula holders for holding a nasal cannula are described. The cannula holders may also be configured to hold a CPAP mask, BPAP mask, nebulizer mask, or any other piece of medical equipment. The cannula holders may be used to help prevent a nasal cannula from coming into contact with unclean surfaces when not in use, helping to keep the nasal cannula clean. The cannula holders may help prevent a nasal cannula from falling onto the floor or elsewhere when not in use. The cannula holders provide an alternative to placing or hanging a nasal cannula on equipment, furniture, or elsewhere.

### BACKGROUND

Nasal cannulas are worn by patients to obtain supplemental oxygen or airflow. A nasal cannula includes a tube worn on the face of a patient and prongs placed in the nostrils of the patient.

A nasal cannula may be temporarily removed from a patient for a variety of reasons. When removed from the patient, a nasal cannula may be placed in a variety of improvised locations. For example, the nasal cannula may be placed on a bed, chair, nightstand, or other furniture. As another example, the nasal cannula may be placed on an oxygen tank valve, monitor, or other piece of equipment. When placed in these locations, the nasal cannula may be exposed to unclean surfaces and become contaminated. In addition, when placed in these locations, the nasal cannula may accidentally fall onto the floor or elsewhere and become contaminated. When the contaminated nasal cannula is placed back on the patient, the chance of infection may increase.

In addition to nasal cannulas, other medical equipment and breathing devices such as CPAP masks, BPAP masks, and nebulizer masks encounter the same problems of contamination.

What is needed is a device for holding a nasal cannula or other medical equipment when not in use. What is needed is a device which will help prevent a nasal cannula from coming into contact with unclean surfaces when not in use, helping to keep the nasal cannula clean.

### SUMMARY

A device for holding a piece of medical equipment is described. The device includes a receptacle configured to hold the piece of medical equipment. The receptacle has an opening, a front surface, and a back surface. The device also includes a coupling element that may be coupled to the back surface of the receptacle. The coupling element may be configured to couple the receptacle to a location. The device may further include a marking surface coupled to the front surface of the receptacle. The marking surface may be configured to be written on with a writing instrument.

A method for holding a piece of medical equipment is described. The method includes providing a receptacle configured to hold the piece of medical equipment, providing a coupling element coupled to a back surface of the receptacle, coupling the receptacle to a location using the coupling element, and inserting the piece of medical equipment into an opening of the receptacle. The method may further include providing a marking surface coupled to a front surface of the receptacle and writing on the marking surface.

### BRIEF DESCRIPTION OF DRAWINGS

FIGS. 1A-1C show one embodiment of a cannula holder 100. FIG. 1A shows a front view of cannula holder 100. FIG. 1B shows a rear view of cannula holder 100. FIG. 1C shows cannula holder 100 in use with a nasal cannula C.

FIGS. 2A-2C show one embodiment of a cannula holder 200. FIG. 2A shows a front view of cannula holder 200. FIG. 2B shows a rear view of cannula holder 200. FIG. 2C shows cannula holder 200 in use with a nasal cannula C.

FIGS. 3A-3C show one embodiment of a cannula holder 300. FIG. 3A shows a front view of cannula holder 300. FIG. 3B shows a rear view of cannula holder 300. FIG. 3C shows cannula holder 300 in use with a nasal cannula C.

### DESCRIPTION

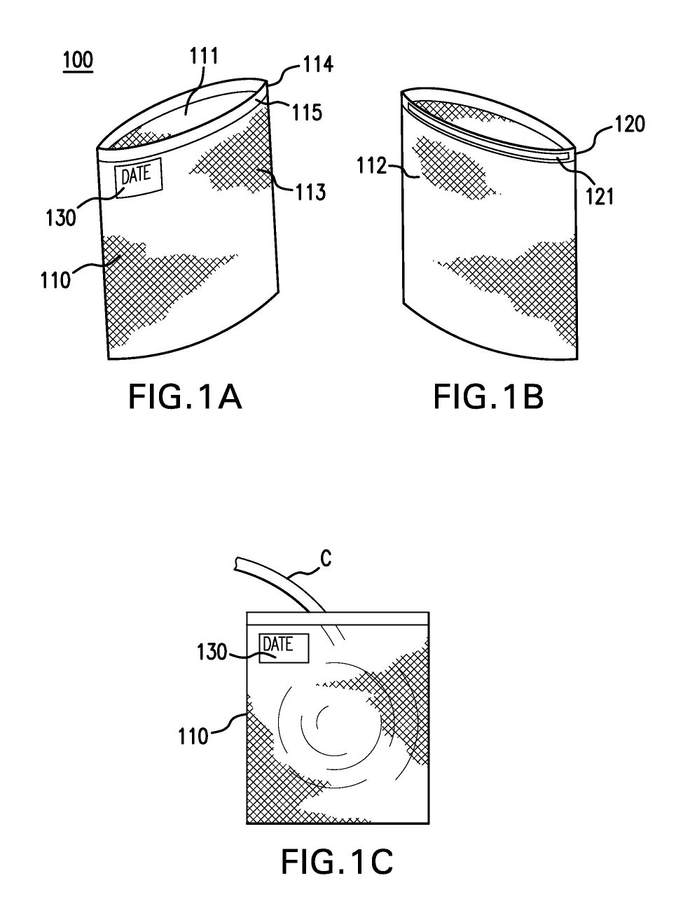

FIGS. 1A-1C show one embodiment of a cannula holder 100. FIG. 1A shows a front view of cannula holder 100. FIG. 1B shows a rear view of cannula holder 100. FIG. 1C shows cannula holder 100 in use with a nasal cannula.

Cannula holder 100 may be configured to hold a nasal cannula. Cannula holder 100 may also be configured to hold a CPAP mask, BPAP mask, nebulizer mask, or any other piece of medical equipment. Cannula holder 100 is configured to help prevent a nasal cannula from coming into contact with unclean surfaces when not in use, helping to keep the nasal cannula clean. Cannula holder 100 prevents a nasal cannula from falling onto the floor or elsewhere when not in use. Cannula holder 100 provides an alternative to placing or hanging a nasal cannula on equipment, furniture, or elsewhere. Cannula holder 100 may be disposable, or may be cleaned and re-used. Cannula holder 100 may be sterilized using gamma sterilization or other methods, and packaged in sterile packaging and removed when ready to be used.

Cannula holder 100 may include a receptacle 110, one or more coupling elements 120, and one or more marking surfaces 130.

Receptacle 110 may include an opening 111, a back surface 112, and a front surface 113. Opening 111 may be configured to receive a nasal cannula. Opening 111 may be reinforced with a trim 114 coupled at or near its mouth. Opening 111 may be configured to lay flat when not in use. Alternatively, opening 111 may be configured to remain at least slightly open to facilitate the insertion of a nasal cannula. Opening 111 may be kept at least slightly open by shaping trim 114, or with a stiffening element 115 such as a metal or plastic wire coupled at or near its mouth.

Receptacle 110 may be rectangular, semicircular, triangular, or any other suitable shape. Receptacle 110 may be capable of being collapsed flat. Receptacle 110 may be configured to conform to a surface or location to which it is intended to be coupled.

Receptacle 110 may be at least partially made of a mesh fabric made of polyester, nylon, cotton, or other suitable fabric. The mesh fabric may be breathable and allow air and moisture to escape. The mesh fabric may have a mesh pattern configured to reduce the likelihood of snagging or catching the nasal cannula, CPAP mask, BPAP mask, nebulizer mask, or any other piece of medical equipment. For example, the mesh fabric may have circular or elliptical openings having a size of approximately 0.5 mm to 1.5 mm, with an open area of approximately 30-50%. The mesh fabric may have a mesh pattern and/or color that allows the contents of receptacle 110 to be at least partially visible. The mesh fabric may be a single layer, double layer, triple layer, or any other suitable type of weave that allows airflow but reduces the possibility of snagging on the medical equipment inserted into receptacle 110. The mesh fabric may be made of a material that does not substantially weaken when exposed to moisture. The mesh fabric may be of a weight that is light, medium, heavy, or any suitable combination of weights. The mesh fabric may be treated with an antimicrobial agent capable of inhibiting the growth of and/or kill microorganisms. The antimicrobial agent may include silver or any other suitable antimicrobial agent. The silver may be in the form of silver nanoparticles bound in a zeolite, calcium carbonate, ceramic, or other suitable matrix, applied to the mesh fabric. The mesh fabric may have inherent antimicrobial properties. Alternatively, receptacle 110 may be at least partially made of a non-mesh fabric, plastic, paper/cellulose, metal, or any other suitable material. Receptacle 110 may be at least partially made of a material that is perforated or non-perforated. Receptacle 110 may be at least partially made of a flexible or rigid material. Any of these materials may be treated with an antimicrobial agent.

Receptacle 110 may be configured to hold a nasal cannula. Receptacle 110 may be configured to enclose all, half, or any portion of a nasal cannula. Receptacle 110 may also be configured to hold a CPAP mask, BPAP mask, nebulizer mask, or any other piece of medical equipment. In one embodiment, receptacle 110 may have a length of approximately 4-15 inches and a width of approximately 4-15 inches. Receptacle 110 may be configured to be breathable to allow for the passage of air to facilitate drying of the nasal cannula or other medical equipment.

Coupling element 120 may be coupled to back surface 112 of receptacle 110. Alternatively, coupling element 120 may be coupled to front surface 113 of receptacle 110, or any suitable portion of receptacle 110. Coupling element 120 may include an adhesive tape 121 with a removable backing, such as a double-sided adhesive tape or other suitable tape. Alternatively, coupling element 120 may include one or more hook-and-loop fasteners, magnets, straps, hooks, rigid or flexible handles, or other suitable coupling elements.

Coupling element 120 may be configured to couple receptacle 110 securely to an oxygen tank, oxygen concentrator, wall, rail, or any other suitable location. Coupling element 120 may be configured to hold up to 2 pounds, up to 3 pounds, up to 4 pounds, or up to 5 pounds. Coupling element 120 may be configured to be easily removed. Coupling element 120 may be one-time use or reusable. Coupling element 120 may be detachable from receptacle 110.

Marking surface 130 may be coupled to front surface 113 of receptacle 110. Alternatively, marking surface 130 may be coupled to back surface 112 of receptacle, or any suitable portion of receptacle 110. Marking surface 130 may be written on with a pen or other writing instrument. Marking surface 130 may include an ink, coating, or material applied to at least a portion of receptacle 110. Marking surface 130 may include a writable ink, a rubberized or plasticized coating, or other material applied to at least a portion of receptacle 110. Alternatively, marking surface 130 may include a label made of paper, fabric, or other suitable material stitched, glued, taped, or otherwise coupled to receptacle 110. Still alternatively, marking surface 130 may include a hang tag tied with a string or otherwise coupled to receptacle 110. Still alternatively, marking surface 130 may be a substantially smooth portion of receptacle 110. Marking surface 130 may be pre-marked with a mark such as “DATE,” “NAME,” or any other suitable mark.

Marking surface 130 may allow a date to be written on receptacle 110. Marking surface 130 may help indicate for how long a nasal cannula and/or cannula holder 100 has been in use, and may help act as a reminder that a new nasal cannula and/or cannula holder 100 is needed. Marking surface 130 may also allow patient name or any other information to be written on receptacle 110.

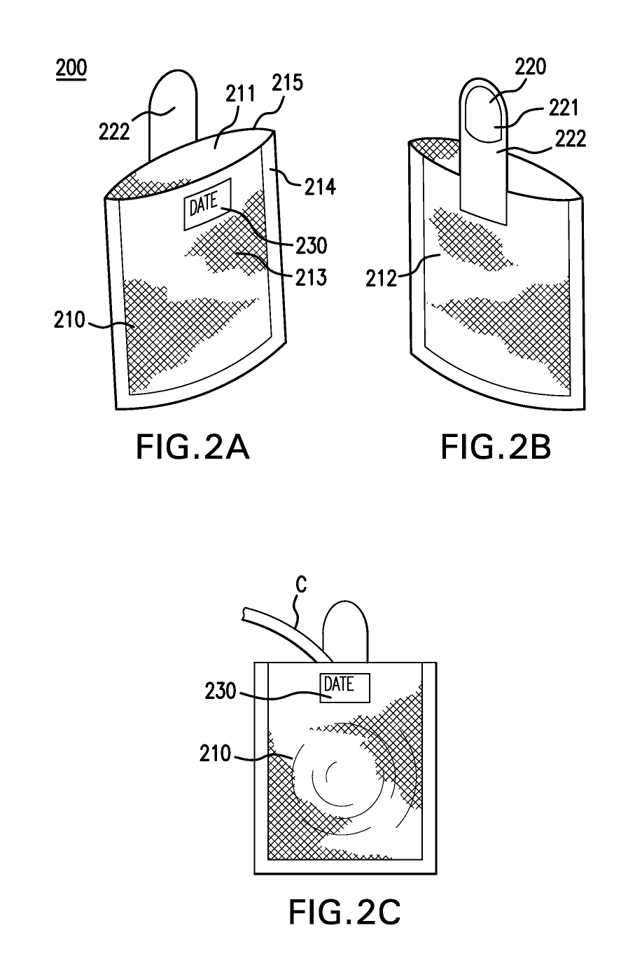

FIGS. 2A-2C show one embodiment of a cannula holder 200. FIG. 2A shows a front view of cannula holder 200. FIG. 2B shows a rear view of cannula holder 200. FIG. 2C shows cannula holder 200 in use with a nasal cannula.

Cannula holder 200 may be configured to hold a nasal cannula. Cannula holder 200 may also be configured to hold a CPAP mask, BPAP mask, nebulizer mask, or any other piece of medical equipment. Cannula holder 200 is configured to help prevent a nasal cannula from coming into contact with unclean surfaces when not in use, helping to keep the nasal cannula clean. Cannula holder 200 prevents a nasal cannula from falling onto the floor or elsewhere when not in use. Cannula holder 200 provides an alternative to placing or hanging a nasal cannula on equipment, furniture, or elsewhere. Cannula holder 200 may be disposable, or may be cleaned and re-used. Cannula holder 200 may be sterilized using gamma sterilization or other methods, and packaged in sterile packaging and removed when ready to be used.

Cannula holder 200 may include a receptacle 210, one or more coupling elements 220, and one or more marking surfaces 230.

Receptacle 210 may include an opening 211, a back surface 212, and a front surface 213. Opening 211 may be configured to receive a nasal cannula. Opening 211 may be configured to lay flat when not in use. Alternatively, opening 211 may be configured to remain at least slightly open to facilitate the insertion of a nasal cannula. Opening 211 may be kept at least slightly open with a stiffening element 215 such as a metal or plastic wire coupled at or near its mouth.

Receptacle 210 may be rectangular, semicircular, triangular, or any other suitable shape. Receptacle 210 may be capable of being collapsed flat. Receptacle 210 may be configured to conform to a surface or location to which it is intended to be coupled.

Receptacle 210 may be at least partially made of a mesh fabric made of polyester, nylon, cotton, or other suitable fabric. The mesh fabric may be breathable and allow air and moisture to escape. The mesh fabric may have a mesh pattern configured to reduce the likelihood of snagging or catching the nasal cannula, CPAP mask, BPAP mask, nebulizer mask, or any other piece of medical equipment. For example, the mesh fabric may have circular or elliptical openings having a size of approximately 0.5 mm to 1.5 mm, with an open area of approximately 30-50%. The mesh fabric may have a mesh pattern and/or color that allows the contents of receptacle 210 to be at least partially visible. The mesh fabric may be a single layer, double layer, triple layer, or any other suitable type of weave that allows airflow but reduces the possibility of snagging on the medical equipment inserted into receptacle 210. The mesh fabric may be made of a material that does not substantially weaken when exposed to moisture. The mesh fabric may be of a weight that is light, medium, heavy, or any suitable combination of weights. The mesh fabric may be treated with an antimicrobial agent capable of inhibiting the growth of and/or kill microorganisms. The antimicrobial agent may include silver or any other suitable antimicrobial agent. The silver may be in the form of silver nanoparticles bound in a zeolite, calcium carbonate, ceramic, or other suitable matrix, applied to the mesh fabric. The mesh fabric may have inherent antimicrobial properties. Receptacle 210 may be reinforced with a trim 214 along one or more edges. Alternatively, receptacle 210 may be at least partially made of a non-mesh fabric, plastic, paper/cellulose, metal, or any other suitable material. Receptacle 210 may be at least partially made of a material that is perforated or non-perforated. Receptacle 210 may be at least partially made of a flexible or rigid material. Any of these materials may be treated with an antimicrobial agent.

Receptacle 210 may be configured to hold a nasal cannula. Receptacle 210 may be configured to enclose all, half, or any portion of a nasal cannula. Receptacle 210 may also be configured to hold a CPAP mask, BPAP mask, nebulizer mask, or any other piece of medical equipment. In one embodiment, receptacle 210 may have a length of approximately 4-15 inches and a width of approximately 4-15 inches. Receptacle 210 may be configured to be breathable to allow for the passage of air to facilitate drying of the nasal cannula or other medical equipment.

Coupling element 220 may be coupled to a hanging tab 222 coupled to back surface 212 of receptacle 210. Alternatively, coupling element 220 may be coupled to back surface 212 of receptacle 210, front surface 213 of receptacle 210, or any suitable portion of receptacle 210. Coupling element 220 may include an adhesive tape 221 with a removable backing, such as a double-sided adhesive tape or other suitable tape. Alternatively, coupling element 220 may include one or more hook-and-loop fasteners, magnets, straps, hooks, rigid or flexible handles, or other suitable coupling elements coupled to hanging tab 222.

Coupling element 220 may be configured to couple receptacle 210 securely to an oxygen tank, oxygen concentrator, wall, rail, or any other suitable location. Coupling element 220 may be configured to hold up to 2 pounds, up to 3 pounds, up to 4 pounds, or up to 5 pounds. Coupling element 220 may be configured to be easily removed. Coupling element 220 may be one-time use or reusable. Coupling element 220 may be detachable from receptacle 210.

Marking surface 230 may be coupled to front surface 213 of receptacle 210. Alternatively, marking surface 230 may be coupled to back surface 212 of receptacle, or any suitable portion of receptacle 210. Marking surface 230 may be written on with a pen or other writing instrument. Marking surface 230 may include an ink, coating, or material applied to at least a portion of receptacle 210. Marking surface 230 may include a writable ink, a rubberized or plasticized coating, or other material applied to at least a portion of receptacle 210. Alternatively, marking surface 230 may include a label made of paper, fabric, or other suitable material stitched, glued, taped, or otherwise coupled to receptacle 210. Still alternatively, marking surface 230 may include a hang tag tied with a string or otherwise coupled to receptacle 210. Still alternatively, marking surface 230 may be a substantially smooth portion of receptacle 210. Marking surface 230 may be pre-marked with a mark such as “DATE,” “NAME,” or any other suitable mark.

Marking surface 230 may allow a date to be written on receptacle 210. Marking surface 230 may help indicate for how long a nasal cannula and/or cannula holder 200 has been in use, and may help act as a reminder that a new nasal cannula and/or cannula holder 200 is needed. Marking surface 230 may also allow patient name or any other information to be written on receptacle 210.

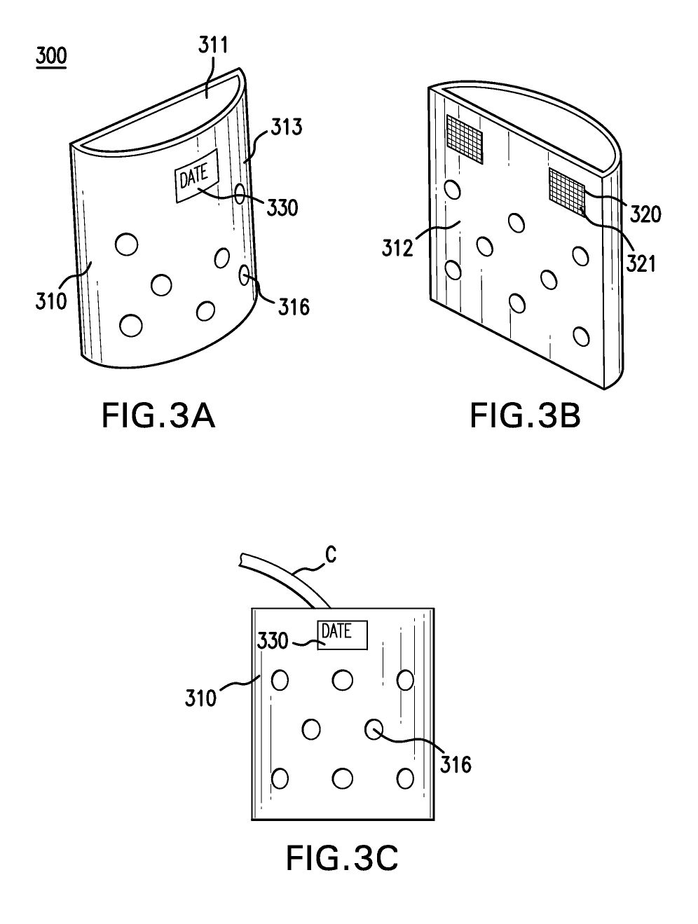

FIGS. 3A-3C show one embodiment of a cannula holder 300. FIG. 3A shows a front view of cannula holder 300. FIG. 3B shows a rear view of cannula holder 300. FIG. 3C shows cannula holder 300 in use with a nasal cannula.

Cannula holder 300 may be configured to hold a nasal cannula. Cannula holder 300 may also be configured to hold a CPAP mask, BPAP mask, nebulizer mask, or any other piece of medical equipment. Cannula holder 300 is configured to help prevent a nasal cannula from coming into contact with unclean surfaces when not in use, helping to keep the nasal cannula clean. Cannula holder 300 prevents a nasal cannula from falling onto the floor or elsewhere when not in use. Cannula holder 300 provides an alternative to placing or hanging a nasal cannula on equipment, furniture, or elsewhere. Cannula holder 300 may be disposable, or may be cleaned and re-used. Cannula holder 300 may be sterilized using gamma sterilization or other methods, and packaged in sterile packaging and removed when ready to be used.

Cannula holder 300 may include a receptacle 310, one or more coupling elements 320, and one or more marking surfaces 330.

Receptacle 310 may include an opening 311, a back surface 312, and a front surface 313. Opening 311 may be configured to receive a nasal cannula.

Receptacle 310 may be rectangular, semicircular, triangular, or any other suitable shape. Receptacle 310 may be capable of being stacked. Receptacle 310 may be configured to conform to a surface or location to which it is intended to be coupled.

Receptacle 310 may be at least partially made of a substantially rigid material such as plastic, metal, or other suitable material. Receptacle 310 may be treated with an antimicrobial agent capable of inhibiting the growth of and/or kill microorganisms. The antimicrobial agent may include silver or any other suitable antimicrobial agent.

Receptacle 310 may be configured to hold a nasal cannula. Receptacle 310 may be configured to enclose all, half, or any portion of a nasal cannula. Receptacle 310 may also be configured to hold a CPAP mask, BPAP mask, nebulizer mask, or any other piece of medical equipment. In one embodiment, receptacle 310 may have a length of approximately 4-15 inches, a width of approximately 4-15 inches, and a depth of approximately 1-3 in. Receptacle 310 may include one or more perforations or holes 316 to allow for the passage of air to facilitate drying of the nasal cannula or other medical equipment.

Coupling element 320 may be coupled to back surface 312 of receptacle 310. Alternatively, coupling element 320 may be coupled to front surface 313 of receptacle 310, or any suitable portion of receptacle 310. Coupling element 320 may include an adhesive tape 321 with a removable backing, such as a double-sided adhesive tape or other suitable tape. Alternatively, coupling element 320 may include one or more hook-and-loop fasteners, magnets, straps, hooks, rigid or flexible handles, or other suitable coupling elements.

Coupling element 320 may be configured to couple receptacle 310 securely to an oxygen tank, oxygen concentrator, wall, rail, or any other suitable location. Coupling element 320 may be configured to hold up to 2 pounds, up to 3 pounds, up to 4 pounds, or up to 5 pounds. Coupling element 320 may be configured to be easily removed. Coupling element 320 may be one-time use or reusable. Coupling element 320 may be detachable from receptacle 310.

Marking surface 330 may be coupled to front surface 313 of receptacle 310. Alternatively, marking surface 330 may be coupled to back surface 312 of receptacle, or any suitable portion of receptacle 310. Marking surface 330 may be written on with a pen or other writing instrument. Marking surface 330 may include an ink, coating, or material applied to at least a portion of receptacle 310. Marking surface 330 may include a writable ink, a rubberized or plasticized coating, or other material applied to at least a portion of receptacle 310. Alternatively, marking surface 330 may include a label made of paper, fabric, or other suitable material stitched, glued, taped, or otherwise coupled to receptacle 310. Still alternatively, marking surface 330 may include a hang tag tied with a string or otherwise coupled to receptacle 310. Still alternatively, marking surface 330 may be a substantially smooth portion of receptacle 310. Marking surface 330 may be pre-marked with a mark such as “DATE,” “NAME,” or any other suitable mark.

Marking surface 330 may allow a date to be written on receptacle 310. Marking surface 330 may help indicate for how long a nasal cannula and/or cannula holder 300 has been in use, and may help act as a reminder that a new nasal cannula and/or cannula holder 300 is needed. Marking surface 330 may also allow patient name or any other information to be written on receptacle 310.

While the foregoing has been with reference to particular embodiments of the invention, it will be appreciated by those skilled in the art that changes in these embodiments may be made without departing from the principles and spirit of the invention.

What is claimed is:

1. A device for holding a piece of medical equipment, the device comprising:
a receptacle configured to hold the piece of medical equipment, the receptacle having an opening, a front surface, and a back surface; and
a coupling element coupled to the back surface of the receptacle, the coupling element configured to couple the receptacle to a location.

2. The device of claim 1, wherein the receptacle is at least partially made of a breathable material.

3. The device of claim 1, wherein the receptacle is at least partially made of a mesh fabric.

4. The device of claim 3, wherein the mesh fabric has been treated with an antimicrobial agent.

5. The device of claim 4, wherein the antimicrobial agent includes silver.

6. The device of claim 1, wherein the coupling element includes an adhesive tape.

7. The device of claim 1, further comprising:
a marking surface coupled to the front surface of the receptacle, the marking surface configured to be written on with a writing instrument.

8. The device of claim 7, wherein the marking surface includes an ink, material, or coating applied to at least a portion of the receptacle.

9. The device of claim 7, wherein the marking surface includes a date mark.

10. The device of claim 7, wherein the marking surface includes a name mark.

11. A method for holding a piece of medical equipment, the method comprising:
providing a receptacle configured to hold the piece of medical equipment;
providing a coupling element coupled to a back surface of the receptacle;
coupling the receptacle to a location using the coupling element; and
inserting the piece of medical equipment into an opening of the receptacle.

12. The method of claim 11, wherein the receptacle is at least partially made of a breathable material.

13. The method of claim 11, wherein the receptacle is at least partially made of a mesh fabric.

14. The method of claim 13, wherein the mesh fabric has been treated with an antimicrobial agent.

15. The method of claim 14, wherein the antimicrobial agent includes silver.

16. The method of claim 11, wherein the coupling element includes an adhesive tape.

17. The method of claim 11, further comprising:
providing a marking surface coupled to a front surface of the receptacle; and
writing on the marking surface.

18. The method of claim 17, wherein the marking surface includes an ink, material, or coating applied to at least a portion of the receptacle.

19. The method of claim 17, wherein writing on the marking surface includes writing a date on the marking surface.

20. The method of claim 17, wherein writing on the marking surface includes writing a name on the marking surface.
